(19) United States
(12) Patent Application Publication
(10) Pub. No.: US 2021/0073669 A1
(43) Pub. Date: Mar. 11, 2021

(54) GENERATING TRAINING DATA FOR MACHINE-LEARNING MODELS

(71) Applicant: American Express Travel Related Services Company, New York, NY (US)

(72) Inventors: Soham Banerjee, Gurgaon (IN); Jayatu Sen Chaudhury, Gurgaon (IN); Prodip Hore, Gurgaon (IN); Rohit Joshi, Gurgaon (IN); Snehansu Sekhar Sahu, Delhi (IN)

(21) Appl. No.: 16/562,972

(22) Filed: Sep. 6, 2019

(51) Int. Cl. G06N 20/00; G06N 3/04; G06K 9/62; G06F 17/18

(52) U.S. Cl. CPC G06N 20/00; G06F 17/18; G06K 9/6256; G06N 3/0454

(57) ABSTRACT

Disclosed are various embodiments for generating training data for machine-learning models. A plurality of original records are analyze to identify a probability distribution function (PDF), wherein a sample space of the PDF comprises the plurality of original records. A plurality of new records are generated using the PDF. An augmented dataset that includes the plurality of new records is created. Then, a machine-learning model is trained using the augmented dataset.

### BACKGROUND

Machine-learning models often require large amounts of data in order to be trained to make accurate predictions, classifications, or inferences about new data. When a dataset is insufficiently large, a machine-learning model may be trained to make incorrect inferences. For example, a small dataset may result in overfitting of the machine-learning model to the data available. This can cause the machine-learning model to become biased towards a particular result due to the omission of particular types of records in the smaller dataset. As another example, outliers in a small dataset may have a disproportionate impact on the performance of the machine-learning model by increasing the variance in the performance of the machine-learning model.

Unfortunately, sufficiently large data sets are not always readily available for use in training a machine-learning model. For example, tracking an occurrence of an event that occurs rarely may lead to a small dataset due to a lack of occurrences of the event. As another example, data related to small population sizes may result in a small dataset due to the limited number of members.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an example implementation of the present disclosure.

FIG. 2 is a drawing of a computing environment according to various embodiments of the present disclosure.

FIG. 3A is a sequence diagram illustrating an example of an interaction between the various components of the computing environment of FIG. 2 according to various embodiments of the present disclosure.

FIG. 3B is a sequence diagram illustrating an example of an interaction between the various components of the computing environment of FIG. 2 according to various embodiments of the present disclosure.

FIG. 4 is a flowchart illustrating one example of functionality of a component implemented within the computing environment of FIG. 2 according to various embodiments of the present disclosure.

### DETAILED DESCRIPTION

Disclosed are various approaches for generating additional data for training machine-learning models to supplement small or noisy datasets that might be insufficient for training a machine-learning model. When only a small dataset is available for training a machine learning model, data scientists can try to expand their datasets by collecting more data. However, this is not always practical. For example, datasets representing events that occur infrequently can only be supplemented by waiting for extended periods of time for additional occurrences of the event. As another example, datasets based on a small population size (e.g., data representing a small group of people) cannot be meaningfully expanded by merely adding more members to the population.

Additional records can be added to these small datasets, but there are disadvantages. For example, one may have to wait for a significant amount of time to collect sufficient data related to events that occur infrequently in order to have a dataset of sufficient size. However, the delay involved in collecting the additional data for these infrequent events may be unacceptable. As another example, one can supplement a dataset based on a small population by obtaining data from other, related populations. However, this may decrease the quality of the data used as the basis for a machine-learning model. In some instances, this decrease in quality may result in an unacceptable impact on the performance of the machine-learning model.

However, according to various embodiments of the present disclosure, it is possible to generate additional records that are sufficiently indistinguishable from previously collected data present in the small dataset. As a result, the small dataset can be expanded using the generated records to a size sufficient to train a desired machine-learning model (e.g., a neural network, Bayesian network, sparse machine vector, decision tree, etc.). In the following discussion, a description of approaches for generating data for machine learning is provided.

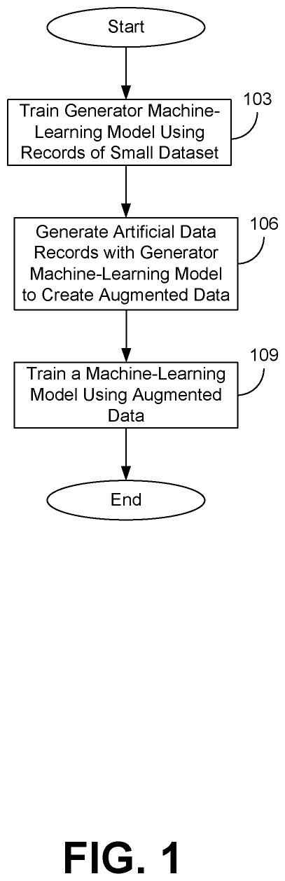

The flowchart depicted in FIG. 1 introduces the approaches used by the various embodiments of the present disclosure. Although FIG. 1 illustrates the concepts of the various embodiments of the present disclosure, additional detail is provided in the discussion of the subsequent Figures.

To begin, at step 103, a small dataset can be used to train a generator machine-learning model to create artificial data records that are similar to those records already present in the small dataset. A dataset may be considered to be small if the dataset is of insufficient size to be used to accurately train a machine-learning model. Examples of small datasets include datasets containing records of events that happen infrequently, or records of members of a small population. The generator machine-learning model can be any neural network or deep neural network, Bayesian network, support vector machine, decision tree, genetic algorithm, or other machine learning approach that can be trained or configured to generate artificial records based at least in part on the small dataset.

For example, the generator machine-learning model can be a component of a generative adversarial network (GAN). In a GAN, a generator machine-learning model and a discriminator machine-learning model are used in conjunction to identify a probability density function (PDF 231) that maps to the sample space of the small dataset. The generator machine-learning model is trained on the small dataset to create artificial data records that are similar to the small dataset. The discriminator machine-learning model is trained to identify real data records by analyzing the small dataset.

The generator machine-learning model and the discriminator machine-learning model can then engage in a competition with each other. The generator machine-learning model is trained through the competition to eventually create artificial data records that are indistinguishable from real data records included in the small dataset. To train the generator machine-learning model, artificial data records created by the generator machine-learning model are provided to the discriminator machine-learning model along with real records from the small dataset. The discriminator machine-learning model then determines which record it believes to be the artificial data record. The result of the discriminator machine-learning model's determination is provided to the generator machine-learning model to train the generator machine-learning model to generate artificial data records that are more likely to be indistinguishable from real records included in the small dataset to the discriminator machine-learning model. Similarly, the discriminator machine-learning model uses the result of its determination to improve its ability to detect artificial data records created by the generator machine-learning model. When the discriminator machine-learning model has an error rate of approximately fifty percent (50%, assuming equal size artificial data is fed to generator), this can be used as an indication that the generator machine-learning model has been trained to create artificial data records that are indistinguishable from real data records already present in the small dataset.

Then, at step 106, the generator machine-learning model can be used to create artificial data records to augment the small dataset. The PDF 231 can be sampled at various points to create artificial data records. Some points may be sampled repeatedly, or clusters of points may be sampled in proximity to each other, according to various statistical distributions (e.g., the normal distribution). The artificial data records can then be combined with the small dataset to create an augmented dataset.

Finally, at step 109, the augmented dataset can be used to train a machine-learning model. For example, if the augmented dataset encompassed customer data for a particular customer profile, the augmented dataset could be used to train a machine-learning model used to make commercial or financial product offers to customers within the customer profile. However, any type of machine-learning model can be trained using an augmented dataset generated in the previously described manner.

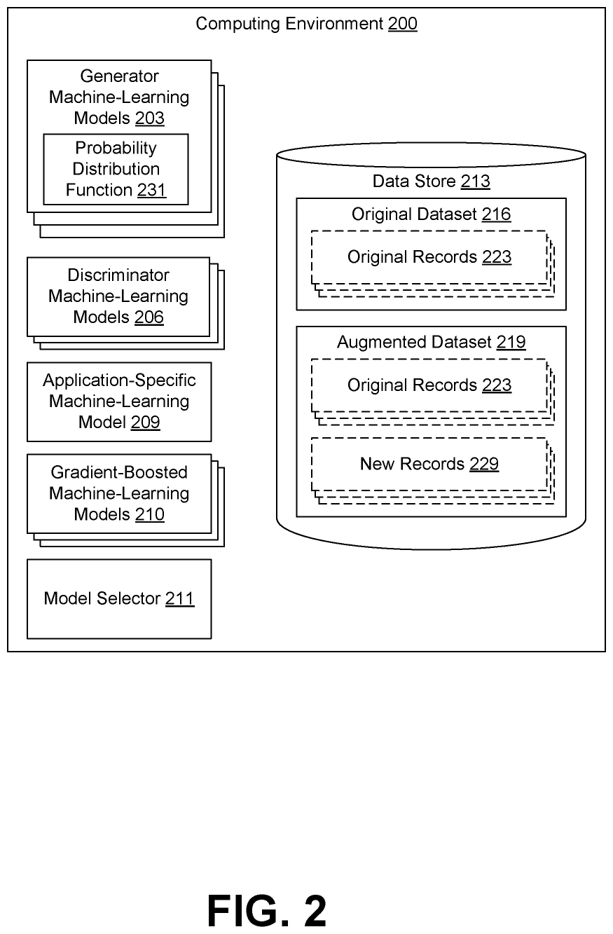

With reference to FIG. 2, shown is a computing environment 200 according to various embodiments of the present disclosure. The computing environment 200 can include a server computer or any other system providing computing capability. Alternatively, the computing environment 203 can employ a plurality of computing devices that can be arranged in one or more server banks or computer banks or other arrangements. Such computing devices can be located in a single installation or can be distributed among many different geographical locations. For example, the computing environment 200 can include a plurality of computing devices that together can include a hosted computing resource, a grid computing resource or any other distributed computing arrangement. In some cases, the computing environment 200 can correspond to an elastic computing resource where the allotted capacity of processing, network, storage, or other computing-related resources can vary over time.

Moreover, individual computing devices within the computing environment 200 can be in data communication with each other through a network. The network can include wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. A network can also include a combination of two or more networks. Examples of networks can include the Internet, intranets, extranets, virtual private networks (VPNs), and similar networks.

Various applications or other functionality can be executed in the computing environment 200 according to various embodiments. The components executed on the computing environment 200 can include one or more generator machine-learning models 203, one or more discriminator machine-learning models 206, an application-specific machine-learning model 209, and a model selector 211. However, other applications, services, processes, systems, engines, or functionality not discussed in detail herein can also be hosted in the computer environment 200, such as when the computing environment 200 is implemented as a shared hosting environment utilized by multiple entities or tenants.

Also, various data is stored in a data store 213 that is accessible to the computing environment 203. The data store 213 can be representative of a plurality of data stores 213, which can include relational databases, object-oriented databases, hierarchical databases, hash tables or similar key-value data stores, as well as other data storage applications or data structures. The data stored in the data store 213 is associated with the operation of the various applications or functional entities described below. This data can include an original dataset 216, an augmented dataset 219, and potentially other data.

The original dataset 216 can represent data which has been collected or accumulated from various real-world sources. The original dataset 216 can include one or more original records 223. Each of the original records 223 can represent an individual data point within the original dataset 216. For example, an original record 223 could represent data related to an occurrence of an event. As another example, an original record 223 could represent an individual within a population of individuals.

Normally, the original dataset 216 can be used to train the application-specific machine-learning model 209 to perform predictions or decisions in the future. However, as previously discussed, sometimes the original dataset 216 can contain an insufficient number of original records 223 for use in training the application-specific machine-learning model 209. Different application-specific machine-learning models 209 can require different minimum numbers of original records 223 as a threshold for acceptably accurate training. In these instances, the augmented dataset 219 can be used to train the application-specific machine-learning model 209 instead of or in addition to the original dataset 216.

The augmented dataset 219 can represent a collection of data that contains a sufficient number of records to train the application-specific machine-learning model 209. Accordingly, the augmented dataset 219 can include both original records 223 that were included in the original dataset 216 as well as new records 229 that were created by a generator machine-learning model 203. Individual ones of the new records 229, while created by the generator machine-learning model 203, are indistinguishable from the original records 223 when compared with the original records 223 by the discriminator machine-learning model 206. As a new record 229 is indistinguishable from an original record 223, the new record 229 can be used to augment the original records 223 in order to provide a sufficient number of records for training the application-specific machine-learning model 209.

The generator machine-learning model 203 represents one or more generator machine-learning models 203 which can be executed to identify a probability density function 231 (PDF 231) that includes the original records 223 within the sample space of the PDF 231. Examples of generator machine-learning models 203 include neural networks or deep neural networks, Bayesian networks, sparse machine vectors, decision trees, and any other applicable machine-learning technique. As there are many different PDFs 231 which can include the original records 223 within their sample space, multiple generator machine-learning models 203 can be used to identify different potential PDFs 231. In these implementations, an appropriate PDF 231 may be selected from the various potential PDFs 231 by the model selector 211, as discussed later.

The discriminator machine-learning model 206 represents one or more discriminator machine-learning models 206 which can be executed to train a respective generator machine-learning model 203 to identify an appropriate PDF 231. Examples of discriminator machine-learning models 206 include neural networks or deep neural networks, Bayesian networks, sparse machine vectors, decision trees, and any other applicable machine-learning technique. As different generator machine-learning models 206 may be better suited for training different generator machine-learning models 203, multiple discriminator machine-learning models 206 can be used in some implementations.

The application-specific machine-learning model 209 can be executed to make predictions, inferences, or recognize patterns when presented with new data or situations. Application-specific machine-learning models 209 can be used in a variety of situations, such as evaluating credit applications, identifying abnormal or fraudulent activity (e.g., erroneous or fraudulent financial transactions), performing facial recognition, performing voice recognition (e.g., to authenticate a user or customer on the phone), as well as various other activities. To perform their functions, application-specific machine-learning models 209 can be trained using a known or preexisting corpus of data. This can include the original dataset 216 or, in situations where the original dataset 216 has an insufficient number of original records 223 to adequately train the application-specific machine-learning model 209, an augmented dataset 219 that has been generated for training purposes.

The gradient-boosted machine-learning models 210 can be executed to make predictions, inferences, or recognize patterns when presented with new data or situations. Each gradient-boosted machine-learning model 210 can represent a machine-learning model created from a PDF 231 identified by a respective generator machine-learning model 203 using various gradient boosting techniques. As discussed later, a best performing gradient-boosted machine-learning model 210 can be selected by the model selector 211 for use as an application-specific machine-learning model 209 using various approaches.

The model selector 211 can be executed to monitor the training progress of individual generator machine-learning models 203 and/or discriminator machine-learning models 206. Theoretically, an infinite number of PDFs 231 exist for the same sample space that includes the original records 223 of the original dataset 216. As a result, some individual generator machine-learning models 203 may identify PDFs 231 that fit the sample space better than other PDFs 231. The better fitting PDFs 231 will generally generate better quality new records 229 for inclusion in the augmented dataset 219 than the PDFs 231 with a worse fit for the sample space. The model selector 211 can therefore be executed to identify those generator machine-learning models 203 that have identified the better fitting PDFs 231, as described in further detail later.

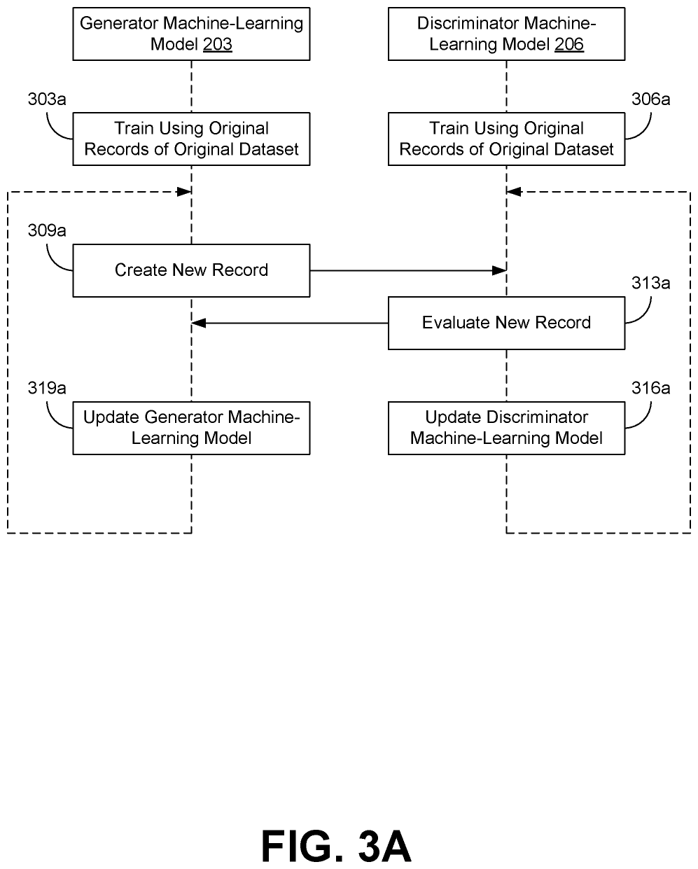

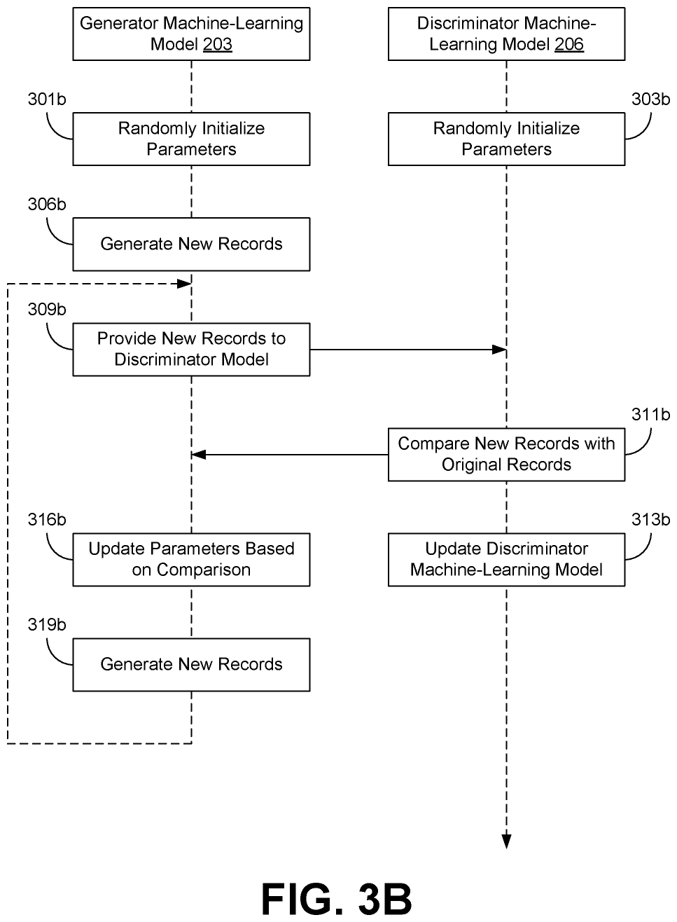

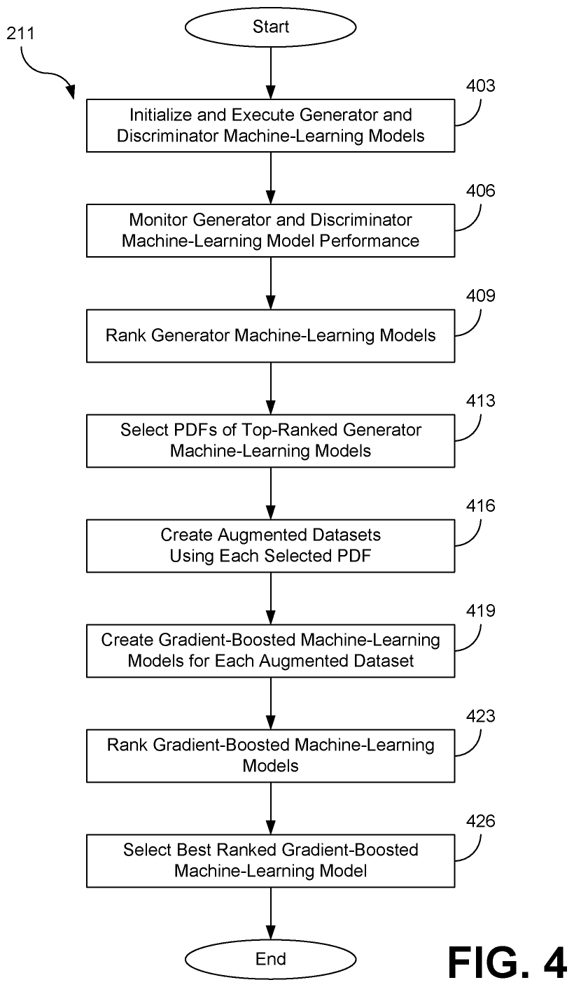

Next, a general description of the operation of the various components of the computing environment 200 is provided. Although the following descripting provides an illustrative example of the operation of and interaction between the various components of the computing environment 200, the operation of individual components is described in further detail in the discussion accompanying FIGS. 3 and 4.

To begin, one or more generator machine-learning models 203 and discriminator machine-learning models 206 can be created to identify an appropriate PDF 231 that includes the original records 223 within a sample space of the PDF 231. As previously discussed, there exists a theoretically infinite number of PDFs 231 that include the original records 223 of the original dataset 216 within the sample space of the PDF 231.

In order to eventually be able to select the most appropriate PDF 231, multiple generator machine-learning models 203 can be used to identify individual PDFs 231. Each generator machine-learning model 203 can differ from other generator machine-learning models 203 in various ways. For example, some generator machine-learning models 203 may have different weights applied to the various inputs or outputs of individual perceptrons within the neural networks that form individual generator machine-learning models 203. Other generator machine-learning models 203 may utilize different inputs with respect to each other. Moreover, different discriminator machine-learning models 206 may be more effective at training particular generator machine-learning models 203 to identify an appropriate PDF 231 for creating new records 229. Similarly, individual discriminator machine-learning models 206 may accept different inputs or have the weights assigned to the inputs or outputs of individual perceptrons that form the underlying neural networks of the individual discriminator machine-learning models 206.

Next, each generator machine-learning model 203 can be paired with each discriminator machine-learning model 206. Although this may be manually be done in some implementations, the model selector 211 can also automatically pair the generator machine-learning models 203 with the discriminator machine-learning models 206 in response to being provided with a list of the generator machine-learning models 203 and discriminator machine-learning models 206 that will be used. In either case, each pair of a generator machine-learning model 203 and a discriminator machine-learning model 206 is registered with the model selector 211 in order for the model selector 211 to monitor and/or evaluate the performance of the various generator machine-learning models 203 and discriminator machine-learning models 206.

Then, the generator machine-learning models 203 and the discriminator machine-learning models 206 can be trained using the original records 223 in the original dataset 216. The generator machine-learning models 203 can be trained to attempt to create new records 229 that are indistinguishable from the original records 223. The discriminator machine-learning models 206 can be trained to identify whether a record it is evaluating is an original record 223 in the original dataset or a new record 229 created by its respective generator machine-learning model 203.

Once trained, the generator machine-learning models 203 and the discriminator machine-learning models 206 can be executed to engage in a competition. In each round of the competition, a generator machine-learning model 203 creates a new record 229, which is presented to the discriminator machine-learning model 206. The discriminator machine-learning model 206 then evaluates the new records 229 to determine whether the new record 229 is an original record 223 or in fact a new record 229. The result of the evaluation is then used to train both the generator machine-learning model 203 and the discriminator machine-learning model 206 to improve the performance of each.

As the pairs of generator machine-learning models 203 and discriminator machine-learning models 206 are executed using the original records 223 to identify a respective PDF 231, the model selector 211 can monitor various metrics related to the performance of the generator machine-learning models 203 and the discriminator machine-learning models 206. For example, the model selector 211 can track the generator loss rank, the discriminator loss rank, the run length, and the difference rank of each pair of generator machine-learning model 203 and discriminator machine-learning model 206. The model selector 211 can also use one or more of these factors to select a preferred PDF 231 from the plurality of PDFs 231 identified by the generator machine-learning models 203.

The generator loss rank can represent how frequently a data record created by the generator machine-learning model 203 is mistaken for an original record 223 in the original dataset 216. Initially, the generator machine-learning model 203 is expected to create low-quality records that are easily distinguishable from the original records 223 in the original dataset 216. However, as the generator machine-learning model 203 continues to be trained through multiple iterations, the generator machine-learning model 203 is expected to create better quality records that become harder for the respective discriminator machine-learning model 206 to distinguish from the original records 223 in the original dataset 216. As a result, the generator loss rank should decrease over time from a one-hundred percent (100%) loss rank to a lower loss rank. The lower the loss rank, the more effective the generator machine-learning model 203 is at creating new records 229 that are indistinguishable to the respective discriminator machine-learning model 206 from the original records 223.

Similarly, the discriminator loss rank can represent how frequently the discriminator machine-learning model 206 fails to correctly distinguish between an original record 223 and a new record 229 created by the respective generator machine-learning model 203. Initially, the generator machine-learning model 203 is expected to create low-quality records that are easily distinguishable from the original records 223 in the original dataset 216. As a result, the discriminator machine-learning model 206 would be expected to have an initial error rate of zero percent (0%) when determining whether a record is an original records 223 or a new records 229 created by the generator machine-learning model 206. As the discriminator machine-learning model 206 continues to be trained through multiple iterations, the discriminator machine-learning model 206 should be able to continue to distinguish between the original records 223 and the new records 229. Accordingly, the higher the discriminator loss rank, the more effective the generator machine-learning model 203 is at creating new records 229 that are indistinguishable to the respective discriminator machine-learning model 206 from the original records 223.

The run length can represent the number of rounds in which the generator loss rank of a generator machine-learning model 203 decreases while the discriminator loss rank of the discriminator machine-learning model 206 simultaneously increases. Generally, a longer run length indicates a better performing generator machine-learning model 203 compared to one with a shorter run length. In some instances, there may be multiple run lengths associated with a pair of generator machine-learning models 203 and discriminator machine-learning models 206. This can occur, for example, if the pair of machine-learning models has several distinct sets of consecutive rounds in which the generator loss rank decreases while the discriminator loss rank increases that are punctuated by one or more rounds in which the simultaneous change does not occur. In these situations, the longest run length may be used for evaluating the generator machine-learning model 203.

The difference rank can represent the percentage difference between the discriminator loss rank and the generator loss rank. The difference rank can vary at different points in training of a generator machine-learning model 203 and a discriminator machine-learning model 206. In some implementations, the model selector 211 can keep track of the difference rank as it changes during training, or may only track the smallest or largest different rank. Generally, a large difference rank between a generator machine-learning model 203 and discriminator machine-learning model 206 is preferred, as this usually indicates that the generator machine-learning model 203 is generating high-quality artificial data that is indistinguishable to a discriminator machine-learning model 206 that is generally able to distinguish between high-quality artificial data and the original records 223.

The model selector 211 can also perform a Kolmogorov-Smirnov test (KS test) to test the fit of a PDF 231 identified by a generator machine-learning model 203 with the original records 223 in the original dataset 216. The smaller the resulting KS statistic, the more likely that a generator machine-learning model 203 has identified a PDF 231 that closely fits the original records 223 of the original dataset 216.

After the generator machine-learning models 203 are sufficiently trained, the model selector 211 can then select one or more potential PDFs 231 identified by the generator machine-learning models 203. For example, model selector 211 could sort the identified PDFs 231 and select a (or multiple) first PDF 231 associated with the longest run lengths, a second PDF 231 associated with lowest generator loss rank, a third PDF 231 associated with the highest discriminator loss rank, a fourth PDF 231 with highest difference rank, and a fifth PDF 231 with the smallest KS statistic. However, it is possible that some PDFs 231 may be the best performing PDF 231 in multiple categories. In these situations, a model selector 211 could select additional PDFs 231 in that category for further testing.

The model selector 211 can then test each of the selected PDFs 231 to determine which one is the best performing PDF 231. To select a PDF 231 created by a generator machine-learning model 203, the model selector 211 can use each PDF 231 identified by a selected generator machine-learning model 203 to create a new dataset that includes new records 229. In some instances, the new records 229 can be combined with the original records 223 to create a respective augmented dataset 219 for each respective PDF 231. One or more gradient-boosted machine-learning models 210 can then be created and trained by the model selector 211 using various gradient boosting techniques. Each of the gradient-boosted machine-learning models 210 can be trained using the respective augmented dataset 219 of a respective PDF 231 or a smaller dataset comprising just the respective new records 229 created by the respective PDF 231. The performance of each gradient-boosted machine-learning model 210 can then be validated using the original records 223 in the original dataset 216. The best performing gradient-boosted machine-learning model 210 can then be selected by the model selector 211 as the application-specific machine-learning model 209 for use in the particular application.

Referring next to FIG. 3A, shown is sequence diagram that provides one example of the interaction between a generator machine-learning model 203 and a discriminator machine-learning model 206 according to various embodiments. As an alternative, the sequence diagram of FIG. 3A can be viewed as depicting an example of elements of a method implemented in the computing environment 200 according to one or more embodiments of the present disclosure.

Beginning with step 303a, a generator machine-learning model 203 can be trained to create artificial data in the form of new records 229. The generator machine-learning model 203 can be trained using the original records 223 present in the original dataset 216 using various machine-learning techniques. For example, the generator machine-learning model 203 can be trained to identify similarities between the original records 223 in order to create a new record 229.

In parallel at step 306a, the discriminator machine-learning model 206 can be trained to distinguish between the original records 223 and new records 229 created by the generator machine-learning model 203. The discriminator machine-learning model 206 can be trained using the original records 223 present in the original dataset 216 using various machine-learning techniques. For example, the discriminator machine-learning model 206 can be trained to identify similarities between the original records 223. Any new record 229 that is insufficiently similar to the original records 223 could, therefore, be identified as not one of the original records 223.

Next at step 309a, the generator machine-learning model 203 creates a new record 229. The new record 229 can be created to be as similar as possible to the existing original records 223. The new record 229 is then supplied to the discriminator machine-learning model 206 for further evaluation.

Then at step 313a, the discriminator machine-learning model 206 can evaluate the new record 229 created by the generator machine-learning model 203 to determine whether it is distinguishable from the original records 223. After making the evaluation, the discriminator machine-learning model 206 can then determine whether its evaluation was correct (e.g., did the discriminator machine-learning model 206 correctly identify the new record 229 as a new record 229 or an original record 223). The result of the evaluation can then be provided back to the generator machine-learning model 203.

At step 316a, the discriminator machine-learning model 206 uses the result of the evaluation performed at step 313a to update itself. The update can be performed using various machine-learning techniques, such as back propagation. As a result of the update, the discriminator machine-learning model 206 is better able to distinguish new records 229 created by the generator machine-learning model 203 at step 309a from original records 223 in the original dataset 216.

In parallel at step 319a, the generator machine-learning model 203 uses the result provided by the discriminator machine-learning model 206 to update itself. The update can be performed using various machine-learning techniques, such as back propagation. As a result of the update, the generator machine-learning model 203 is better able to generate new records 229 that are more similar to the original records 223 in the original dataset 216 and, therefore, harder to distinguish from the original records 223 by the discriminator machine-learning model 206.

After updating the generator machine-learning model 203 and the discriminator machine-learning model 206 at steps 316a and 319a, the two machine-learning models can continue to be trained further by repeating steps 309a through 319a. The two machine-learning models may repeat steps 309a through 319a for a predefined number of iterations or until a threshold condition is met, such as when the discriminator loss rank of the discriminator machine-learning model 206 and/or the generator loss rank preferably reaches a predefined percentage (e.g., fifty percent).

FIG. 3B depicts sequence diagram that provides a more detailed example of the interaction between a generator machine-learning model 203 and a discriminator machine-learning model 206. As an alternative, the sequence diagram of FIG. 3B can be viewed as depicting an example of elements of a method implemented in the computing environment 200 according to one or more embodiments of the present disclosure.

Beginning with step 301b, parameters for the generator machine-learning model 203 can be randomly initialized. Similarly at step 303b, parameters for the discriminator machine-learning model 206 can also be randomly initialized.

Then at step 306b, the generator machine-learning model 203 can generate new records 229. The initial new records 229 may be of poor quality and/or be random in nature because the generator machine-learning model 203 has not yet been trained.

Next at step 309b, the generator machine-learning model 203 can pass the new records 229 to the discriminator machine-learning model 206. In some implementations, the original records 223 can also be passed to the discriminator machine-learning model 206. However, in other implementations, the original records 223 may be retrieved by the discriminator machine-learning model 206 in response to the

[symbol]

Proceeding to step 311b, the discriminator machine-learning model 206 can compare the first set of new records 229 to the original records 223. For each of the new records 229, the discriminator machine-learning model 206 can identify the new record 229 as one of the new records 229 or as one of the original records 223. The results of this comparison are passed back to the generator machine-learning model.

Next at step 313b, the discriminator machine-learning model 206 uses the result of the evaluation performed at step 311b to update itself. The update can be performed using various machine-learning techniques, such as back propagation. As a result of the update, the discriminator machine-learning model 206 is better able to distinguish new records 229 created by the generator machine-learning model 203 at step 306b from original records 223 in the original dataset 216.

Then at step 316b, the generator machine-learning model 203 can update its parameters to improve the quality of new records 229 that it can generate. The update can be based at least in part on the result of the comparison between the first set of new records 229 and the original records 223 performed by the discriminator machine-learning model 206 at step 311b. For example, individual perceptrons in the generator machine-learning model 203 can be updated using the results received from the discriminator machine-learning model 206 using various forward and/or back-propagation techniques.

Proceeding to step 319b, the generator machine-learning model 203 can create an additional set of new records 229. This additional set of new records 229 can be created using the updated parameters from step 316b. These additional new records 229 can then be provided to the discriminator machine-learning model 206 for evaluation and the results can be used to further train the generator machine-learning model 203 as described previously at steps 309b-316b. This process can continue to be repeated until, preferably, the error rate of the discriminator machine-learning model 206 is approximately 50%, assuming equal amounts of new records 229 and original records 223, or as otherwise allowed by hyperparameters.

Referring next to FIG. 4, shown is a flowchart that provides one example of the operation of a portion of the model selector 211 according to various embodiments. It is understood that the flowchart of FIG. 4 provides merely an example of the many different types of functional arrangements that can be employed to implement the operation of the illustrated portion of the model selector 211. As an alternative, the flowchart of FIG. 4 can be viewed as depicting an example of elements of a method implemented in the computing environment 200, according to one or more embodiments of the present disclosure.

Beginning with step 403, the model selector 211 can initialize one or more generator machine-learning models 203 and one or more discriminator machine-learning models 206 begin their execution. For example, the model selector 211 can instantiate several instances of the generator machine-learning model 203 using randomly selected weights for the inputs of each instance of the generator machine-learning model 203. Likewise, the model selector 211 can instantiate several instances of the discriminator machine-learning model 206 using randomly selected weights for the inputs of each instance of the discriminator machine-learning model 206. As another example, the model selector 211 could select previously created instances or variations of the generator machine-learning model 203 and/or the discriminator machine-learning model 206. The number of generator and discriminator machine-learning models 203 and 206 instantiated may be randomly selected or selected according to a predefined or previously specified criterion (e.g., a predefined number specified in a configuration of the model selector 211). Each instantiated instance of a generator machine-learning model 203 can also be paired with each instantiated instance of a discriminator machine-learning model 206, as some discriminator machine-learning models 206 may better suited for training a particular generator machine-learning model 203 compared to other discriminator machine-learning models 206.

Then at step 406, the model selector 211 then monitors the performance of each pair of generator and discriminator machine-learning models 203 and 206 as they create new records 229 to train each other according to the process illustrated in the sequence diagram of FIG. 3A or 3B. For each iteration of the process depicted in FIG. 3A or 3B, the model selector 211 can track, determine, evaluate, or otherwise identify relevant performance data related to the paired generator and discriminator machine-learning models 203 and 206. These performance indicators can include the run length, generator loss rank, discriminator loss rank, difference rank, and KS statistics for the paired generator and discriminator machine-learning model 203 and 206.

Subsequently at step 409, the model selector 211 can rank each generator machine-learning model 203 instantiated at step 403 according to the performance metrics collected at step 406. This ranking can occur in response to various conditions. For example, the model selector 211 can perform the ranking after a predefined number of iterations of each generator machine-learning model 203 has been performed. As another example, the model selector 211 can perform the ranking after a specific threshold condition or event has occurred, such as one or more of the pairs of generator and discriminator machine-learning models 203 and 206 reaching a minimum run length, or crossing a threshold value for the generator loss rank, discriminator loss rank, and/or difference rank.

The ranking can be conducted in any number of ways. For example, the model selector 211 could create multiple rankings for the generator machine-learning models 206. A first ranking could be based on the run length. A second ranking could be based on the generator loss rank. A third ranking could be based on the discriminator loss rank. A fourth ranking could be based on the difference rank. Finally, a fifth ranking could be based on the KS statistics for the generator machine-learning model 203. In some instances, a single ranking that takes each of these factors into account could also be utilized.

Next at step 413, the model selector 211 can select the PDF 231 associated with each of the top-ranked generator machine-learning models 203 that were ranked at step 409. For example, the model selector 211 could choose a first PDF 231 representing the PDF 231 of the generator machine-learning model 203 associated with the longest run length, a second PDF 231 representing the PDF 231 of the generator machine-learning model 203 associated with the lowest generator loss rank, a third PDF 231 representing the PDF 231 of the generator machine-learning model 203 associated with the highest discriminator loss rank, a fourth PDF 231 representing the PDF 231 of the generator machine-learning model 203 associated with the highest difference rank, or a fifth PDF 231 representing the PDF 231 of the generator machine-learning model 203 associated with the best KS statistics. However, additional PDFs 231 can also be selected (e.g., the top two, three, five, etc., in each category).

Proceeding to step 416, the model selector 211 can create separate augmented datasets 219 using each of the PDFs 231 selected at step 413. To create an augmented dataset 219, the model selector 211 can use the respective PDF 231 to generate a predefined or previously specified number of new records 229. For example, each respective PDF 231 could be randomly sampled or selected at a predefined or previously specified number of points in the sample space defined by the PDF 231. Each set of new records 229 can then be stored in the augmented dataset 219 in combination with the original records 223. However, in some implementations, the model selector 211 may store only new records 229 in the augmented dataset 219.

Then at step 419, the model selector 211 can create a set of gradient-boosted machine-learning model 210. For example, the XGBOOST library can be used to create gradient-boosted machine-learning models 210. However, other gradient boosting libraries or approaches can also be used. Each gradient-boosted machine-learning model 210 can be trained using a respective one of the augmented datasets 219.

Subsequently at step 423, the model selector 211 can rank the gradient-boosted machine-learning models 210 created at step 419. For example, the model selector 211 can validate each of the gradient-boosted machine-learning models 210 using the original records 223 in the original dataset 216. As another example, the model selector 211 can validate each of the gradient-boosted machine-learning models 210 using out of time validation data or other data sources. The model selector 211 can then rank each of the gradient-boosted machine-learning models 210 based on their performance when validated using the original records 223 or the out of time validation data.

Finally, at step 426, the model selector 211 can select the best or most highly ranked gradient-boosted machine-learning model 210 as the application-specific machine-learning model 209 to be used. The application-specific machine-learning model 209 can then be used to make predictions related to events or populations represented by the original dataset 216.

A number of software components previously discussed are stored in the memory of the respective computing devices and are executable by the processor respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of the implementation of portions of the various applications previously discussed. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession in the flowcharts or sequence diagrams can be executed concurrently or with partial concurrence. Further, in some embodiments, one or more of the blocks shown in the flowcharts or sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 200.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory;
a training dataset stored in the memory, the training dataset comprising a plurality of records; and
a first machine-learning model stored in the memory that, when executed by the processor, cause the computing device to at least:
analyze the training dataset to identify common characteristics of the plurality of records; and
repeatedly generate a new record based at least in part on the identified common characteristics of the plurality of records; and
a second machine-learning model stored in the memory that, when executed by the processor, cause the computing device to at least:
analyze the training dataset to identify common characteristics of the plurality of records;
repeatedly evaluate the new record generated by the first machine-learning model to determine whether the new record is indistinguishable from the plurality of records in the training data set;
repeatedly update the first machine-learning model based on the evaluation of the new record; and
repeatedly update the second machine-learning model based on the evaluation of the new record.

2. The system of claim 1, wherein:
the first machine-learning model causes the computing device to generate a plurality of new records; and
the system further comprises a third machine-learning model stored in the memory that is trained using the plurality of new records generated by the first machine-learning model.

3. The system of claim 1, wherein the plurality of new records are generated in response to a determination that the second machine-learning model is unable to distinguish between the new record generated by the first machine-learning model and individual ones of the plurality of records in the training dataset.

4. The system of claim 1, wherein the plurality of new records are generated from a random sample of a predefined number of points in the sample space defined by a probability density function (PDF) identified by the first machine-learning model.

5. The system of claim 1, wherein the first machine-learning model repeatedly generates the new record until the second machine-learning model is unable to distinguish the new record from the plurality of records in the training data set at a predefined rate.

6. The system of claim 1, wherein the predefined rate is fifty percent when equal size new records care created.

7. The system of claim 1, wherein the first machine-learning model and the second machine-learning model are neural networks.

8. A computer-implemented method, comprising:
analyzing a plurality of original records to identify a probability distribution function (PDF), wherein a sample space of the PDF comprises the plurality of original records;
generating a plurality of new records using the PDF;
creating an augmented dataset that comprises the plurality of new records; and
training a machine-learning model using the augmented dataset.

9. The computer-implemented method of claim 8, wherein analyzing the plurality of original records to identify the probability distribution function further comprises:
training a generator machine-learning model to create a new record that is similar to individual ones of the plurality of original records;
training a discriminator machine-learning model to distinguish between the new record and the individual ones of the plurality of original records; and
identifying the probability distribution function in response to the new record created by the generator machine-learning model being mistaken by the discriminator machine-learning model at a predefined rate.

10. The computer-implemented method of claim 9, wherein the predefined rate is approximately fifty percent of comparisons performed by the discriminator between the new record and the plurality of original records.

11. The computer-implemented method of claim 9, wherein the generator machine-learning model is one of a plurality of generator machine-learning models and the method further comprises:
training each of the plurality of generator machine-learning models to create the new record that is similar to individual ones of the plurality of original records;
selecting the generator machine-learning model from the plurality of generator machine learning models based at least in part on:
a run length associated with each generator machine-learning model and the discriminator machine-learning model,
a generator loss rank associated with each generator machine-learning model and the discriminator machine-learning model,
a discriminator loss rank associated with each generator machine-learning model and the discriminator machine-learning model,
a different rank associated with each generator machine-learning model and the discriminator machine-learning model, or
at least one result of a Kolmogorov-Smirnov (KS) test that includes a first probability distribution function associated with the plurality of original records and a second probability distribution function associated with the plurality of new records; and
identifying the probability distribution function further occurs in response to selecting the generator machine-learning model from the plurality of generator machine learning models.

12. The computer-implemented method of claim 8, wherein generating the plurality of new records using the probability distribution function further comprises randomly selecting a predefined number of points in the sample space defined by the probability distribution function.

13. The computer-implemented method of claim 8, further comprising adding the plurality of original records to the augmented dataset.

14. The computer-implemented method of claim 8, wherein the machine learning model comprises a neural network.

15. A system, comprising:
a computing device comprising a processor and a memory; and
machine-readable instructions stored in the memory that, when executed by the processor, cause the computing device to at least:
analyze a plurality of original records to identify a probability distribution function (PDF), wherein a sample space of the PDF comprises the plurality of original records;
generate a plurality of new records using the PDF;
create an augmented dataset that comprises the plurality of new records; and
train a machine-learning model using the augmented dataset.

16. The system of claim 15, wherein the machine-readable instructions that cause the computing device to analyze the plurality of original records to identify the probability distribution function further cause the computing device to at least:
train a generator machine-learning model to create a new record that is similar to individual ones of the plurality of original records;
train a discriminator machine-learning model to distinguish between the new record and the individual ones of the plurality of original records; and
identify the probability distribution function in response to the new record created by the generator machine-learning model being mistaken by the discriminator machine-learning model at a predefined rate.

17. The system of claim 16, wherein the predefined rate is approximately fifty percent of comparisons performed by the discriminator between the new record and the plurality of original records.

18. The system of claim 16, wherein the generator machine-learning model is one of a plurality of generator machine-learning models and the machine-readable instructions further cause the computing device to at least:
train each of the plurality of generator machine-learning models to create the new record that is similar to individual ones of the plurality of original records;
select the generator machine-learning model from the plurality of generator machine learning models based at least in part on:
a run length associated with each generator machine-learning model and the discriminator machine-learning model,
a generator loss rank associated with each generator machine-learning model and the discriminator machine-learning model,
a discriminator loss rank associated with each generator machine-learning model and the discriminator machine-learning model,
different rank associated with each generator machine-learning model and the discriminator machine-learning model, or
at least one result of a Kolmogorov-Smirnov (KS) test that includes a first probability distribution function associated with the plurality of original records and a second probability distribution function associated with the plurality of new records; and
identification of the probability distribution function further occurs in response to selecting the generator machine-learning model from the plurality of generator machine learning models.

19. The system of claim 15, wherein the machine-readable instructions that cause the computing device to generate the plurality of new records using the probability distribution function further cause the computing device to randomly select a predefined number of points in the sample space defined by the probability distribution function.

20. The system of claim 15, wherein the machine-readable instructions, when executed by the processor, further cause the computing device to at least add the plurality of original records to the augmented dataset.
